(19) United States
(12) Patent Application Publication
(10) Pub. No.: US 2016/0127993 A1
(43) Pub. Date: May 5, 2016

(54) ANTENNA TUNER CONTROL FOR WAN/WLAN ANTENNA SHARING

(71) Applicant: QUALCOMM Incorporated, San Diego, CA (US)

(72) Inventor: Jibing Wang, San Diego, CA (US)

(21) Appl. No.: 14/532,896

(22) Filed: Nov. 4, 2014

(51) Int. Cl. H04W 52/02

(52) U.S. Cl. CPC H04W 52/0216; H04W 52/0229; H04W 88/06

(57) ABSTRACT

Methods, systems, and devices are described for wireless communication at a UE. The UE may communicate using a shared antenna communicatively coupled with a first radio and a second radio. When the UE identifies an upcoming transition to a sleep mode for the first radio, a tune code for the shared antenna may be adjusted for the second radio. A tune code query may be transmitted to the second radio which may respond with a tune code response. Adjusting the tune code may be based on the tune code response. This allows the second radio to communicate using the shared antenna while the first radio is in the sleep mode. When the UE identifies a transition from the sleep mode for the first radio, the UE may adjust the tune code for the shared antenna for the first radio, allowing the first radio to communicate using the shared antenna.

### BACKGROUND

1. Field of Disclosure

The following relates generally to wireless communication, and more specifically to antenna tuner control for wide area network (WAN)/wireless local area network (WLAN) antenna sharing.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system).

By way of example, a wireless multiple-access communications system may include a number of base stations, each simultaneously supporting communication for multiple communication devices, which may be otherwise known as user equipment (UEs). A base station may communicate with the communication devices on downlink channels (e.g., for transmissions from a base station to a UE) and uplink channels (e.g., for transmissions from a UE to a base station).

UEs may include a plurality of radios. At times, radios within a UE may be used to communicate using different radio access technologies (RATs). In some cases, an antenna may be used with a number of different radios, such as a shared antenna. Difficulties may arise from using the shared antenna with multiple radios, since the radios may operate using different frequency bands or power constraints. In some cases, not all of the radios may tune the shared antenna.

### SUMMARY

The present disclosure may relate generally to wireless communications systems, and more particularly to improved systems, methods, or apparatuses for antenna tuner control for WAN/WLAN antenna sharing. A UE may communicate using a shared antenna that may be communicatively coupled with at least a first radio and a second radio. When the UE identifies an upcoming transition to a sleep mode for the first radio, a tune code for the shared antenna may be adjusted for the second radio. In some examples, a tune code query is transmitted to the second radio and a tune code response, responsive to the tune code query, is received in response. The UE may adjust the tune code for the shared antenna for the second radio based on the tune code response. This allows the second radio to communicate using the shared antenna while the first radio is in the sleep mode. When the UE identifies a transition from the sleep mode for the first radio, the UE may adjust the tune code for the shared antenna for the first radio, allowing the first radio to communicate using the shared antenna. In some examples, adjusting the tune code for the shared antenna includes accessing a historical record for tune codes. The UE may receive a measurement or feedback based on the transmitted signal. The UE may adjust the tune code for the shared antenna based on the received measurement or feedback.

A method of wireless communication at a UE is described. The method may include communicating using a shared antenna that is communicatively coupled with at least a first radio and a second radio, identifying an upcoming transition to a sleep mode for the first radio, and adjusting a tune code for the shared antenna for the second radio based at least in part on the upcoming transition to the sleep mode for the first radio.

An apparatus for wireless communication at a UE is described. The apparatus may include a communication manager for communicating using a shared antenna that is communicatively coupled with at least a first radio and a second radio, a sleep determiner for identifying an upcoming transition to a sleep mode for the first radio, and a tuner for adjusting a tune code for the shared antenna for the second radio based at least in part on the upcoming transition to the sleep mode for the first radio.

A further apparatus for wireless communication at a UE is described. The apparatus may include a processor, memory in electronic communication with the processor, and instructions stored in the memory, wherein the instructions are executable by the processor to communicate using a shared antenna that is communicatively coupled with at least a first radio and a second radio, identify an upcoming transition to a sleep mode for the first radio, and adjust a tune code for the shared antenna for the second radio based at least in part on the upcoming transition to the sleep mode for the first radio.

A non-transitory computer-readable medium storing code for wireless communication at a UE is described. The code may include instructions executable to communicate using a shared antenna that is communicatively coupled with at least a first radio and a second radio, identify an upcoming transition to a sleep mode for the first radio, and adjust a tune code for the shared antenna for the second radio based at least in part on the upcoming transition to the sleep mode for the first radio.

In some examples of the method, apparatuses, or non-transitory computer-readable medium described above, the adjusting the tune code for the shared antenna includes transmitting a tune code query to the second radio, receiving a tune code response, responsive to the tune code query, and adjusting the tune code for the shared antenna for the second radio based at least in part on the tune code response. Additionally or alternatively, in some examples the tune code response comprises at least one of a second radio tune code, or a second radio frequency band, or a second radio timing, or a second radio bandwidth, or a second radio power, or combinations thereof.

Some examples of the method, apparatuses, or non-transitory computer-readable medium described above may further include identifying a transition from the sleep mode for the first radio, and adjusting the tune code for the shared antenna for the first radio based at least in part on the transition from the sleep mode for the first radio. Additionally or alternatively, in some examples the adjusting the tune code for the shared antenna comprises accessing a historical record for tune codes for the second radio, and adjusting the tune code for the shared antenna based at least in part on the historical record for tune codes for the second radio.

In some examples of the method, apparatuses, or non-transitory computer-readable medium described above, the adjusting the tune code comprises accessing a recent tune code within the historical record for tune codes, and adjusting the tune code for the shared antenna for the second radio based at least in part on the recent tune code. Additionally or alternatively, some examples may include transmitting a signal using the shared antenna from the second radio.

Some examples of the method, apparatuses, or non-transitory computer-readable medium described above may further include receiving a measurement based at least in part on the transmitted signal, and adjusting the tune code for the shared antenna for the second radio based at least in part on the received measurement. Additionally or alternatively, some examples may include receiving feedback based at least in part on the transmitted signal, and adjusting the tune code for the shared antenna for the second radio based at least in part on the received feedback.

In some examples of the method, apparatuses, or non-transitory computer-readable medium described above, the first radio is a wide area network (WAN) radio and the second radio is a wireless local area network (WLAN). Additionally or alternatively, in some examples the tune code is adjusted using a radio frequency front end (RFFE) bus.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communications system for antenna tuner control for wide area network (WAN)/wireless local area network (WLAN) antenna sharing in accordance with various aspects of the present disclosure;

FIG. 2 illustrates an example of a wireless communications subsystem for antenna tuner control for WAN/WLAN antenna sharing in accordance with various aspects of the present disclosure;

FIG. 3 illustrates an example of a process flow diagram for antenna tuner control for WAN/WLAN antenna sharing in accordance with various aspects of the present disclosure;

FIG. 4 shows a block diagram of a user equipment (UE) configured for antenna tuner control for WAN/WLAN antenna sharing in accordance with various aspects of the present disclosure;

FIG. 5 shows a block diagram of a UE configured for antenna tuner control for WAN/WLAN antenna sharing in accordance with various aspects of the present disclosure;

FIG. 6 shows a block diagram of a shared antenna manager configured for antenna tuner control for WAN/WLAN antenna sharing in accordance with various aspects of the present disclosure;

FIG. 7 illustrates a block diagram of a system including a UE configured for antenna tuner control for WAN/WLAN antenna sharing in accordance with various aspects of the present disclosure;

FIG. 8 shows a flowchart illustrating a method for antenna tuner control for WAN/WLAN antenna sharing in accordance with various aspects of the present disclosure;

FIG. 9 shows a flowchart illustrating a method for antenna tuner control for WAN/WLAN antenna sharing in accordance with various aspects of the present disclosure;

FIG. 10 shows a flowchart illustrating a method for antenna tuner control for WAN/WLAN antenna sharing in accordance with various aspects of the present disclosure;

FIG. 11 shows a flowchart illustrating a method for antenna tuner control for WAN/WLAN antenna sharing in accordance with various aspects of the present disclosure;

FIG. 12 shows a flowchart illustrating a method for antenna tuner control for WAN/WLAN antenna sharing in accordance with various aspects of the present disclosure; and

FIG. 13 shows a flowchart illustrating a method for antenna tuner control for WAN/WLAN antenna sharing in accordance with various aspects of the present disclosure.

### DETAILED DESCRIPTION

The described features generally relate to improved systems, methods, or apparatuses for antenna tuner control for WAN/WLAN antenna sharing. A UE may communicate using a shared antenna that may be communicatively coupled with at least a first radio and a second radio. When the UE identifies an upcoming transition to a sleep mode for the first radio, a tune code for the shared antenna may be adjusted for the second radio. In some examples, a tune code query is transmitted to the second radio and a tune code response, responsive to the tune code query, is received in response. The UE may adjust the tune code for the shared antenna for the second radio based on the tune code response. This allows the second radio to communicate using the shared antenna while the first radio is in the sleep mode. When the UE identifies a transition from the sleep mode for the first radio, the UE may adjust the tune code for the shared antenna for the first radio, allowing the first radio to communicate using the shared antenna. In some examples adjusting the tune code for the shared antenna includes accessing a historical record for tune codes. The UE may receive a measurement or feedback based on the transmitted signal. The UE may adjust the tune code for the shared antenna based on the received measurement or feedback.

By adjusting the tuning of the shared antenna based on the active radio, the described features provide communication settings at the shared antenna for the active radio. Further, in some cases only a subset of the radios, such as the first radio, are able to adjust the tuning of the shared antenna. In these cases, the described features provide communication settings for the shared antenna by allowing a radio that is able to adjust the tuning of the shared antenna (i.e., the first radio) to adjust the tuning of the shared antenna for a radio that is not able to adjust the tuning of the shared antenna (i.e., the second radio).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

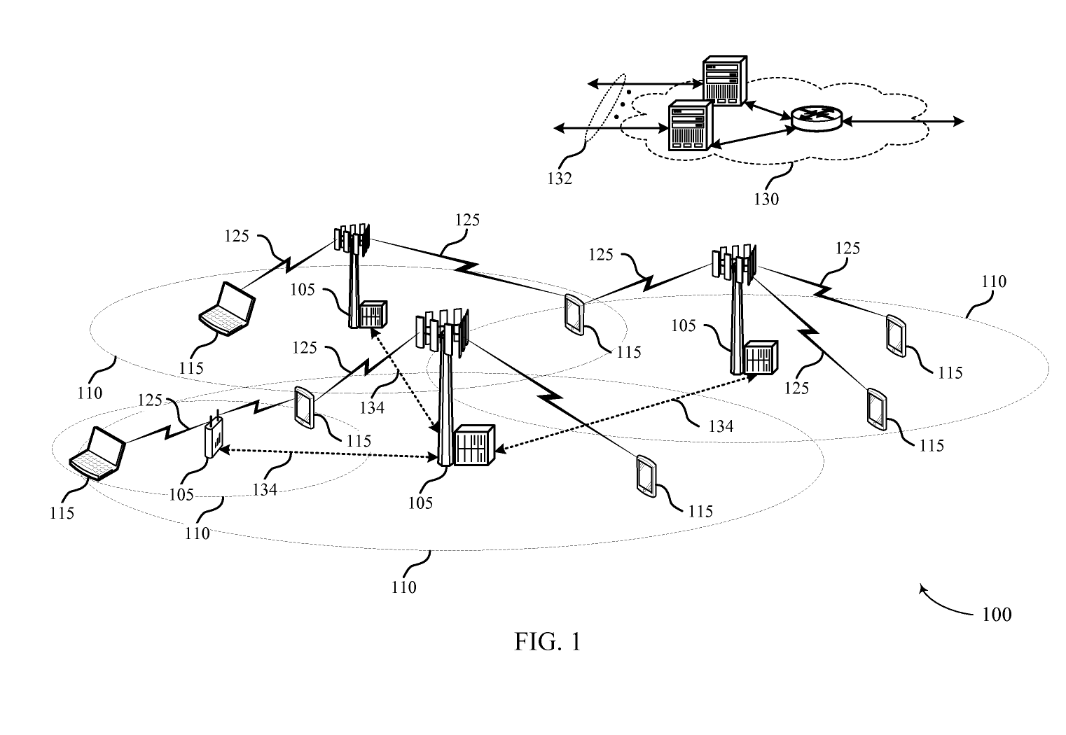

FIG. 1 illustrates an example of a wireless communications system 100 in accordance with various aspects of the present disclosure. The wireless communications system 100 includes base stations 105, at least one UE 115, and a core network 130. The core network 130 may provide user authentication, access authorization, tracking, internet protocol (IP) connectivity, and other access, routing, or mobility functions. The base stations 105 interface with the core network 130 through backhaul links 132 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with one another over backhaul links 134 (e.g., X1, etc.), which may be wired or wireless communication links.

The base stations 105 may wirelessly communicate with the UEs 115 via at least one base station antennas. Each of the base stations 105 may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro or small cell base stations). There may be overlapping geographic coverage areas 110 for different technologies

In some examples, the wireless communications system 100 is a Long Term Evolution (LTE)/LTE-Advanced (LTE-A) network. In LTE/LTE-A networks, the term evolved node B (eNB) may be generally used to describe the base stations 105, while the term UE may be generally used to describe the UEs 115. The wireless communications system 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs 115 with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). In some cases, the wireless communications system 100 may have base stations 105 which support communications using different radio access technologies (RATs). For example, the wireless communications system 100 may include WAN (e.g., LTE) base stations as well as WLAN (e.g., Wi-Fi) base stations. In some examples, UEs 115 may be able to communicate using multiple RATs, such as with different base stations.

The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack and data in the user plane may be based on the IP. A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARD) to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels.

The UEs 115 may be dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, or downlink (DL) transmissions, from a base station 105 to a UE 115. The downlink transmissions may also be called forward link transmissions while the uplink transmissions may also be called reverse link transmissions. Each communication link 125 may include at least one carrier, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

In some embodiments of the wireless communications system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple input multiple output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and at least one uplink CC for carrier aggregation. Carrier aggregation may be used with both FDD and TDD component carriers.

A UE 115 may collaboratively communicate with multiple eNBs 105 through, for example, Multiple Input Multiple Output (MIMO), Coordinated Multi-Point (CoMP), or other schemes. MIMO techniques use multiple antennas on the base stations or multiple antennas on the UE to take advantage of multipath environments to transmit multiple data streams. CoMP includes techniques for dynamic coordination of transmission and reception by a number of eNBs to improve overall transmission quality for UEs as well as increasing network and spectrum utilization.

Carriers may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined. For TDD frame structures, each subframe may carry UL or DL traffic, and special subframes may be used to switch between DL and UL transmission. Allocation of UL and DL subframes within radio frames may be symmetric or asymmetric and may be statically determined or may be reconfigured semi-statically. Special subframes may carry DL or UL traffic and may include a Guard Period (GP) between DL and UL traffic. Switching from UL to DL traffic may be achieved by setting a timing advance at the UE 115 without the use of special subframes or a guard period. UL-DL configurations with switch-point periodicity equal to the frame period (e.g., 10 ms) or half of the frame period (e.g., 5 ms) may also be supported. For example, TDD frames may include at least one special frame, and the period between special frames may determine the TDD DL-to-UL switch-point periodicity for the frame. Use of TDD offers flexible deployments without requiring paired UL-DL spectrum resources. In some TDD network deployments, interference may be caused between UL and DL communications (e.g., interference between UL and DL communication from different base stations, interference between UL and DL communications from base stations and UEs, interference between radios at a UE, etc.). For example, where different base stations 105 serve different UEs 115 within overlapping coverage areas according to different TDD UL-DL configurations, a UE 115 attempting to receive and decode a DL transmission from a serving base station 105 can experience interference from UL transmissions from other, proximately located UEs 115.

Wireless communications system 100 may operate in an ultra high frequency (UHF) frequency region using frequency bands from 700 MHz to 2600 MHz (2.6 GHz), although in some cases wireless local area networks (WLANs) may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communications system 100 may also utilize extremely high frequency (EHF) portions of the spectrum (e.g., from 30 GHz to 300 GHz). This region may also be known as the millimeter band, since the wavelengths range from approximately one millimeter to one centimeter in length. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions.

A UE 115 may communicate using a shared antenna that may be communicatively coupled with at least a first radio and a second radio. When the UE 115 identifies an upcoming transition to a sleep mode for the first radio, a tune code for the shared antenna may be adjusted for the second radio. In some examples, a tune code query is transmitted to the second radio and a tune code response, responsive to the tune code query, is received in response. The UE 115 may adjust the tune code for the shared antenna for the second radio based on the tune code response. This allows the second radio to communicate using the shared antenna while the first radio is in the sleep mode. When the UE 115 identifies a transition from the sleep mode for the first radio, the UE 115 may adjust the tune code for the shared antenna for the first radio, allowing the first radio to communicate using the shared antenna. In some examples adjusting the tune code for the shared antenna includes accessing a historical record for tune codes. The UE 115 may receive a measurement or feedback based on the transmitted signal. The UE 115 may adjust the tune code for the shared antenna based on the received measurement or feedback.

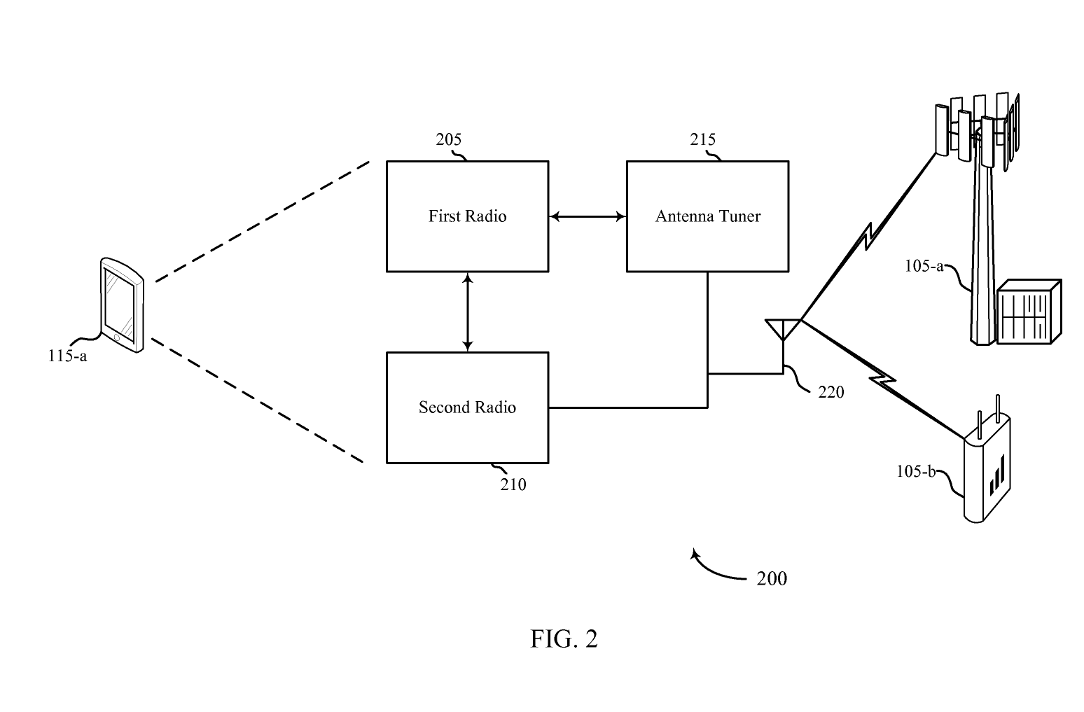

FIG. 2 illustrates an example of a wireless communications subsystem 200 for antenna tuner control for WAN/WLAN antenna sharing in accordance with various aspects of the present disclosure. Wireless communications subsystem 200 may include a UE 115-a, which may be an example of a UE 115 described above with reference to FIG. 1. Wireless communications subsystem 200 may also include a first base station 105-a and a second base station 105-b, which may be examples of a base station 105 described above with reference to FIG. 1. In some cases, the first base station 105-a may be a WAN base station 105-a and the second base station 105-b may be a WLAN access point 105-b.

The UE 115-a may include a first radio 205, a second radio 210, an antenna tuner 215, and a shared antenna 220. It should be noted that the wireless communications subsystem 200 may include any number of radios, antennas (and tuners), and receiving devices, though only two radios, one antenna, and two receiving devices are illustrated. The first radio 205 and the second radio 210 may communicate using similar or different technologies and/or frequencies. The first radio 205 may employ a first radio access technology (RAT), such as WAN technology, and the second radio 210 may employ a second RAT, such as WLAN technology. The shared antenna 220 may be capable of transmitting or receiving across a number of RATs (i.e., the RATs utilized by the connected radios) such as both WAN technologies and WLAN technologies.

The shared antenna 220 may be coupled, such as electronically, to the antenna tuner 215. The antenna tuner 215 may be used to adjust operational characteristics of the shared antenna 220, such as a tune code. The tune code may include any or any combination thereof of an impedance, a frequency band, a bandwidth, timing information, a power, etc. The tune code may be used to adjust the shared antenna 220, such as to prepare the shared antenna 220 for transmission or reception from a radio. In some cases, the shared antenna 220 may warrant a different tune code for each radio, such as the first radio 205 and the second radio 210. For example, the first radio 205 may use a different frequency band than another radio, such as the second radio 210. To effectively operate with the first radio 205, the shared antenna 220 may need to be tuned (e.g., using the antenna tuner 215) to a tune code specific to the first radio 205, such as a first radio tune code. If the shared antenna 220 is to subsequently be used with the second radio 210, the shared antenna 220 may need to be tuned (e.g., using the antenna tuner 215) to a tune code specific to the second radio 210, such as a second radio tune code. By tuning the shared antenna 220 to the appropriate tune code for the current radio, the wireless communications subsystem 200 is able to effectively communicate with multiple base stations 105-a or access points 105-b, which may use different RATs, while conserving resources by using a shared antenna 220.

In some examples, a subset of the radios, such as only the first radio 205, are coupled with the antenna tuner 215. In order for the second radio 210 to effectively communicate using the shared antenna 220, the first radio 205 may adjust the antenna tuner 215 to a tune code appropriate for the second radio 210, such as a second radio tune code. The first radio 205 and the second radio 210 may communicate with one another. In some cases, the second radio 210 may send information (e.g., timing information, priority information, sleep information, a tune code, etc.) to the first radio 205. The first radio 205 may use the received second radio information when adjusting the antenna tuner 215 for the second radio 210. In some examples, the first radio 205 may prompt or request the information from the second radio 210. Additionally or alternatively, the first radio 205 may acquire the second radio information from another source (e.g., another radio, a database, historical records of tune codes, a base station, etc.).

The radios (e.g., the first radio 205 and the second radio 210) may, at times, enter a sleep mode. In some examples, when in a sleep mode a radio does not transmit or receive signals, which may conserve power. A radio entering a sleep mode may occur in conjunction with a base station temporarily ceasing communications with the radio. The radio may enter the sleep mode periodically or as signaled by the network (e.g., based on completion of signal transmission or reception, based on capacity, based on signal quality, etc.).

If the first radio 205 and the second radio 210 attempt to use the shared antenna 220 simultaneously, one or both signals may be degraded (i.e., signal quality may be reduced). Therefore, the radios may be coordinated to determine when each of the radios is able to use the shared antenna 220 (i.e., adjust the antenna tuner 215 to a tune code for the radio). In some examples, the first radio 205 is generally higher in priority than the second radio 210. As such, the first radio 205 may have priority and use the shared antenna 220 when it is not in the sleep mode. However, the second radio 210 may use the shared antenna 220 if the priority of the transmission from, or a reception at, the second radio 210 exceeds the priority of the first radio 205, or the priority of a transmission from or reception at the first radio 205. In some cases, the second radio 210 may use the shared antenna 220 when the first radio 205 is in the sleep mode. At times, the first radio 205 may adjust the antenna tuner 215 to a tune code from or for another radio, such as the second radio 210, before entering the sleep mode, and may adjust the antenna tuner 215 to a tune code for the first radio 205 upon leaving the sleep mode.

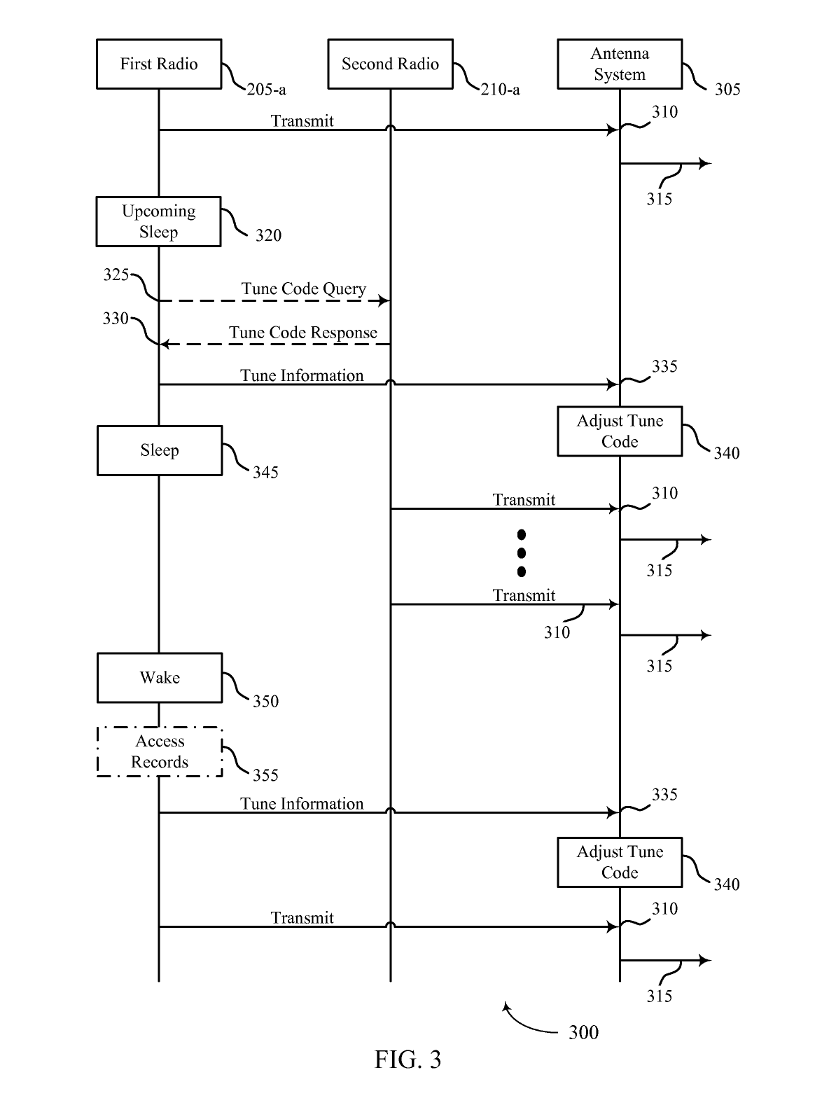

FIG. 3 illustrates an example of a process flow diagram 300 for antenna tuner control for WAN/WLAN antenna sharing in accordance with various aspects of the present disclosure. Process flow diagram 300 may include a first radio 205-a, which may be an example of a first radio 205 described above with reference to FIG. 2. Process flow diagram 300 may also include a second radio 210-a, which may be an example of a second radio 210 described above with reference to FIG. 2. Process flow diagram 300 may also include an antenna system 305. In some examples, antenna system 305 may be an example of one or both of an antenna tuner 215 or a shared antenna 220 described above with reference to FIG. 2. In some cases, the first radio 205-a, second radio 210-a, and antenna system 305 may be a part of a UE 115, which may be an example of a UE 115 described above with reference to FIGS. 1-2.

At times, the first radio 205-a may transmit signals 310 to the antenna system 305. The antenna system 305 may then transmit signals 315 to another antenna(s), such as to another UE, a base station, or an access point. It should be noted, even though signal transmission is shown during steps 310 and 315, reception of signals, bidirectional communication, or any combination thereof may occur. During steps 310 and 315, the UE 115 may communicate using a shared antenna, such as part of the antenna system 305, that may be communicatively coupled with at least the first radio 205-a and the second radio 210-a. In some cases, the antenna system 305 may communicate using only one radio at a time, such as the first radio 205-a or the second radio 210-a.

The first radio 205-a may identify an upcoming transition to a sleep mode 320 for the first radio 205-a. In some examples, the first radio 205-a may transmit a tune code query 325 to the second radio 210-a. In some cases, the tune code query 325 may include information relating to the first radio 205-a, such as tune code information, frequency band information, timing information, bandwidth information, etc., or antenna tuner or shared antenna information or capabilities. The first radio 205-a may receive a tune code response 330, responsive to the tune code query 325, such as from the second radio 210-a. The tune code response 330 may include information relating to the second radio 210-a, such as a second radio tune code, a second radio frequency band, a second radio timing, a second radio bandwidth, a second radio power, etc.

The first radio 205-a may send tune information 335 to the antenna system 305. The tune information 335 may be based on the tune code response 330, and may similarly include a tune code, a frequency band, a timing, a bandwidth, a power, etc. The antenna system 305 may adjust the tune code 340 for the shared antenna. Adjusting the tune code 340 may be based at least in part on the tune information 335. Further, adjusting the tune code 340 may increase the efficiency or signal quality of signals to be transmitted or received using the antenna system 305, based on the radio using the antenna system 305.

The first radio 205-a may enter the sleep mode 345, or it may be determined that the first radio 205-a is sleeping. Entering the sleep mode 345 may be based on network or UE settings or signals, and may further be based on the tune information 335 (e.g., the first radio 205-a may be prevented from sleeping until the tune information 335 is sent to the antenna system 305, etc.).

In some examples, after the antenna system 305 has adjusted the tune code 340 or after the first radio 205-a enters the sleep mode 345, the second radio 210-a may communicate, such as sending signals 310 to and transmitting signals 315 from the antenna system 305, such as using a shared antenna.

The first radio 205-a may exit the sleep mode 350 (e.g., enter an active mode), or it may be determined that the first radio 205-a is no longer sleeping, or a transition from the sleep mode may be identified.

In some examples, historical records may be accessed 355. The historical records 355 may include records of tune codes, such as recently used tune codes. The first radio 205-a may send tune information 335 to the antenna system 305. In some cases, the tune information 335 may be based on the historical records 355 (e.g., the tune information 335 may include the most recent tune code used for the first radio 205-a, etc.). The tune code may be adjusted 340, based on the tune information 335, for use with the first radio 205-a. The first radio 205-a may then communicate using the antenna system 305.

In some examples, measurements may be performed or feedback may be received based on transmissions from the antenna system 305. The measurements or feedback may be used to further adjust the tune code 340 of the antenna system 305. Additionally or alternatively, the measurements or feedback may be used to adjust the historical records of tune codes 355.

It should be noted that even though a step may be discussed as being performed at or by, or being transmitted to, the first radio 205-a, etc., the steps may be performed by any or all of the first radio 205-a, the second radio 210-a, the antenna system 305, or any other UE or network component.

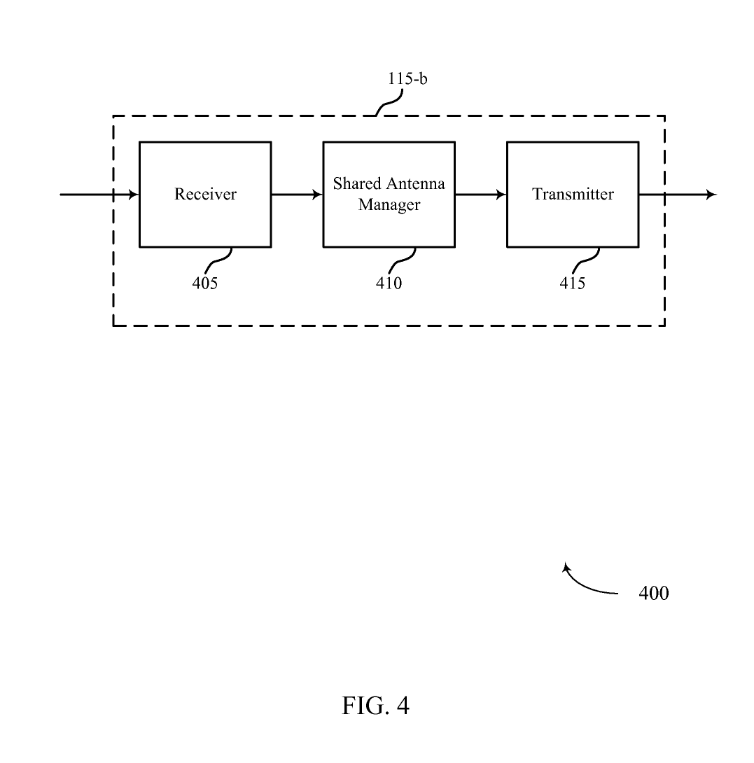

FIG. 4 shows a block diagram 400 of a UE 115-b configured for antenna tuner control for WAN/WLAN antenna sharing in accordance with various aspects of the present disclosure. UE 115-b may be an example of aspects of a UE 115 described with reference to FIGS. 1-3. UE 115-b may include a receiver 405, a shared antenna manager 410, or a transmitter 415. UE 115-b may also include a processor or a database. Each of these components may be in communication with each other.

The components of UE 115-b (as well as those of other related apparatus described herein) may, individually or collectively, be implemented with at least one application specific integrated circuit (ASIC) adapted to perform some or all of the applicable functions in hardware. Alternatively, the functions may be performed by other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by at least one general or application-specific processor.

The receiver 405 may receive information such as packets, user data, or control information associated with various information channels (e.g., control channels, data channels, and information related to antenna tuner control for WAN/WLAN antenna sharing, etc.). Information may be passed on to the shared antenna manager 410, and to other components of UE 115-b.

The shared antenna manager 410 may communicate using a shared antenna that is communicatively coupled with at least a first radio and a second radio, identify an upcoming transition to a sleep mode for the first radio, and adjust a tune code for the shared antenna for the second radio based at least in part on the upcoming transition to the sleep mode for the first radio.

The transmitter 415 may transmit signals received from other components of UE 115-b. In some embodiments, the transmitter 415 may be collocated with the receiver 405 in a transceiver module. The transmitter 415 may include a single antenna, or it may include a plurality of antennas.

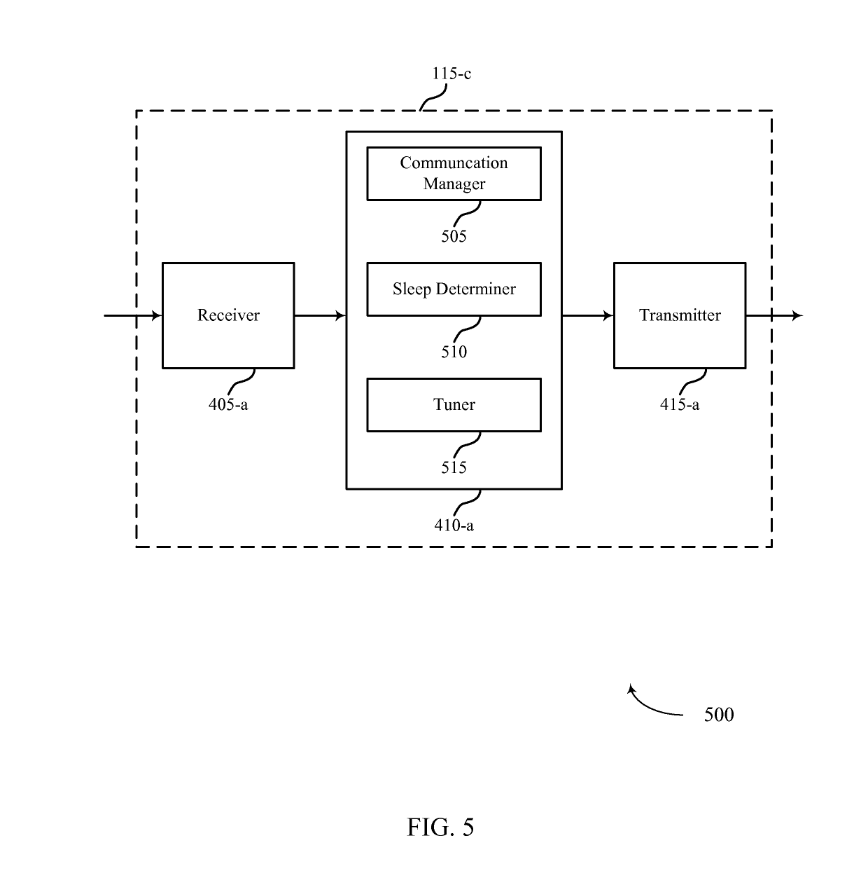

FIG. 5 shows a block diagram 500 of a UE 115-c for antenna tuner control for WAN/WLAN antenna sharing in accordance with various aspects of the present disclosure. UE 115-c may be an example of aspects of a UE 115 described with reference to FIGS. 1-4. UE 115-c may include a receiver 405-a, a shared antenna manager 410-a, or a transmitter 415-a. UE 115-c may also include a processor. Each of these components may be in communication with each other. The shared antenna manager 410-a may also include a communication manager 505, a sleep determiner 510, and a tuner 515.

The receiver 405-a may receive information which may be passed on to shared antenna manager 410-a, and to other components of UE 115-c. The shared antenna manager 410-a may perform the operations described above with reference to FIG. 4. The transmitter 415-a may transmit signals received from other components of UE 115-c.

The communication manager 505 may communicate using a shared antenna that is communicatively coupled with at least a first radio and a second radio as described above with reference to FIGS. 2-3. The communication manager 505 may also transmit a signal using the shared antenna from the second radio.

The sleep determiner 510 may identify an upcoming transition to a sleep mode for the first radio as described above with reference to FIGS. 2-3. The sleep determiner 510 may also identify a transition from the sleep mode for the first radio.

The tuner 515 may adjust a tune code for the shared antenna as described above with reference to FIGS. 2-3. In some cases, the tuner 515 may adjust a tune code for the shared antenna for the second radio based at least in part on the upcoming transition to the sleep mode for the first radio. In some examples, the adjusting the tune code for the shared antenna comprises transmitting a tune code query to the second radio. The tuner 515 may also receive a tune code response, responsive to the tune code query. The tuner 515 may also adjust the tune code for the shared antenna for the second radio based at least in part on the tune code response. In some examples, the tune code response comprises at least a second radio tune code, or a second radio frequency band, or a second radio timing, or a second radio bandwidth, or a second radio power, or combinations thereof. The tuner 515 may also adjust the tune code for the shared antenna for the first radio based at least in part on the transition from the sleep mode for the first radio. The tuner 515 may also adjust the tune code for the shared antenna based at least in part on the historical record for tune codes for the second radio. The tuner 515 may also adjust the tune code for the shared antenna for the second radio based at least in part on a recent tune code from the historical records for tune codes. The tuner 515 may also adjust the tune code for the shared antenna for the second radio based at least in part on a received measurement. The tuner 515 may also adjust the tune code for the shared antenna for the second radio based at least in part on a received feedback.

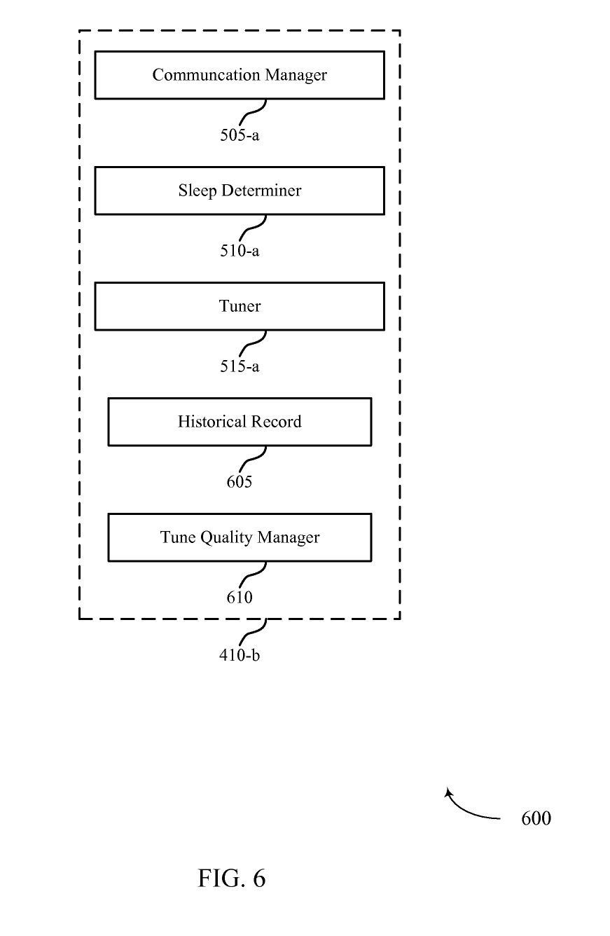

FIG. 6 shows a block diagram 600 of a shared antenna manager 410-b for antenna tuner control for WAN/WLAN antenna sharing in accordance with various aspects of the present disclosure. The shared antenna manager 410-b may be an example of aspects of a shared antenna manager 410 described with reference to FIGS. 4-5. The shared antenna manager 410-b may include a communication manager 505-a, a sleep determiner 510-a, and a tuner 515-a. Each of these modules may perform the functions described above with reference to FIG. 5. The shared antenna manager 410-b may also include a historical record 605, and a tune quality manager 610.

The historical record 605 may be configured such that adjusting the tune code for the shared antenna may include accessing a historical record for tune codes for the second radio, for the first radio, or a recent tune code as described above with reference to FIGS. 2-3. In some examples, adjusting the tune code comprises accessing a recent tune code within the historical record for tune codes. The historical record 605 may include a database.

The tune quality manager 610 may adjust antenna tuning or historical record tune information as described above with reference to FIGS. 2-3. In some cases, the tune quality manager 610 may receive a measurement based at least in part on a transmitted signal. The tune quality manager 610 may also receive feedback based at least in part on a transmitted signal.

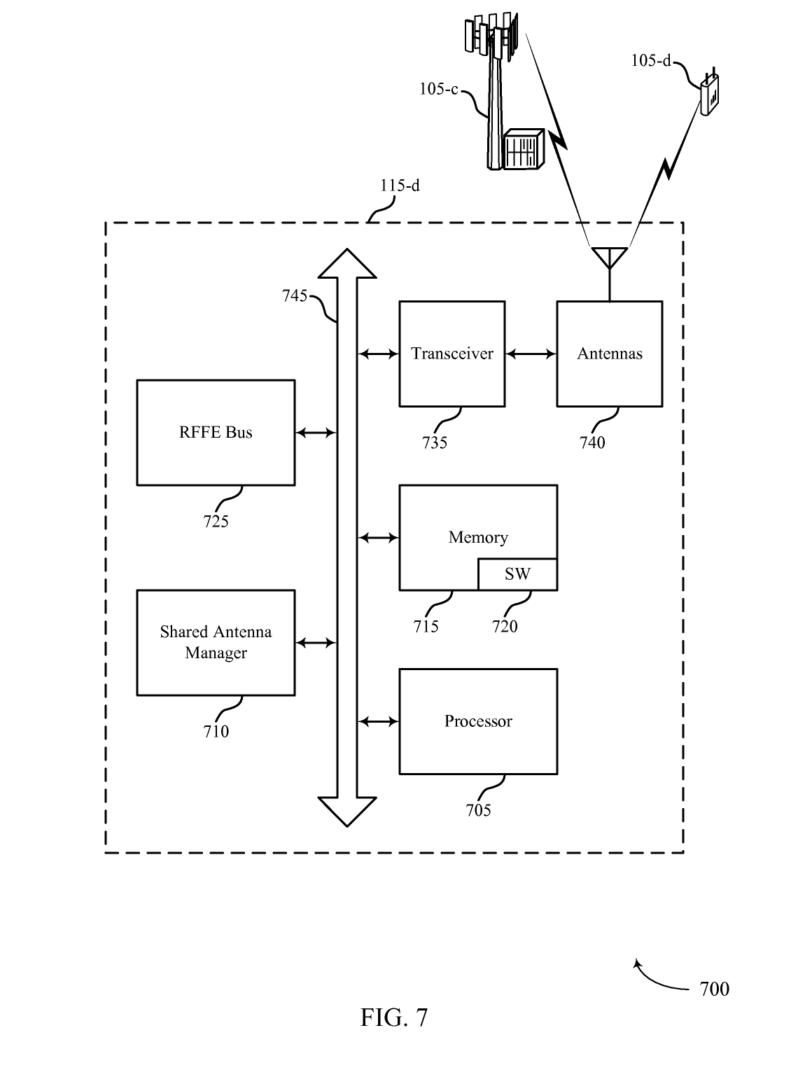

FIG. 7 shows a diagram of a system 700 including a UE 115 configured for antenna tuner control for WAN/WLAN antenna sharing in accordance with various aspects of the present disclosure. System 700 may include UE 115-d, which may be an example of a UE 115 described above with reference to FIGS. 1-6. UE 115-d may include a shared antenna manager 710, which may be an example of a shared antenna manager 410 described with reference to FIGS. 4-6. UE 115-d may also include a radio frequency front end (RFFE) bus 725. UE 115-d may also include components for bi-directional voice and data communications including components for transmitting communications and components for receiving communications. For example, UE 115-d may communicate bi-directionally with base station 105-c or base station 105-d.

The RFFE bus 725 may facilitate communication between a radio of the UE 115-d and an antenna tuner of the UE 115-d. The tune code may be adjusted using the radio frequency front end (RFFE) bus 725 as described above with reference to FIGS. 2-3. In some cases, not all radios of the UE 115-d support the RFFE bus 725.

UE 115-d may also include a processor module 705, and memory 715 (including software (SW)) 720, a transceiver module 735, and at least one antenna(s) 740, each of which may communicate, directly or indirectly, with one another (e.g., via buses 745). The transceiver module 735 may communicate bi-directionally, via the antenna(s) 740 or wired or wireless links, with at least one network, as described above. For example, the transceiver module 735 may communicate bi-directionally with a base station 105 or another UE 115. The transceiver module 735 may include a modem to modulate the packets and provide the modulated packets to the antenna(s) 740 for transmission, and to demodulate packets received from the antenna(s) 740. While UE 115-d may include a single antenna 740, UE 115-d may also have multiple antennas 740 capable of concurrently transmitting or receiving multiple wireless transmissions. Additionally or alternatively, the UE 115-d may include a single shared antenna or multiple shared antennas capable of concurrently transmitting or receiving multiple wireless transmissions from a number of radios.

The memory 715 may include random access memory (RAM) and read only memory (ROM). The memory 715 may store computer-readable, computer-executable software/firmware code 720 including instructions that, when executed, cause the processor module 705 to perform various functions described herein (e.g., antenna tuner control for WAN/WLAN antenna sharing, etc.). Alternatively, the software/firmware code 720 may not be directly executable by the processor module 705 but cause a computer (e.g., when compiled and executed) to perform functions described herein. The processor module 705 may include an intelligent hardware device, (e.g., a central processing unit (CPU), a microcontroller, an ASIC, etc.)

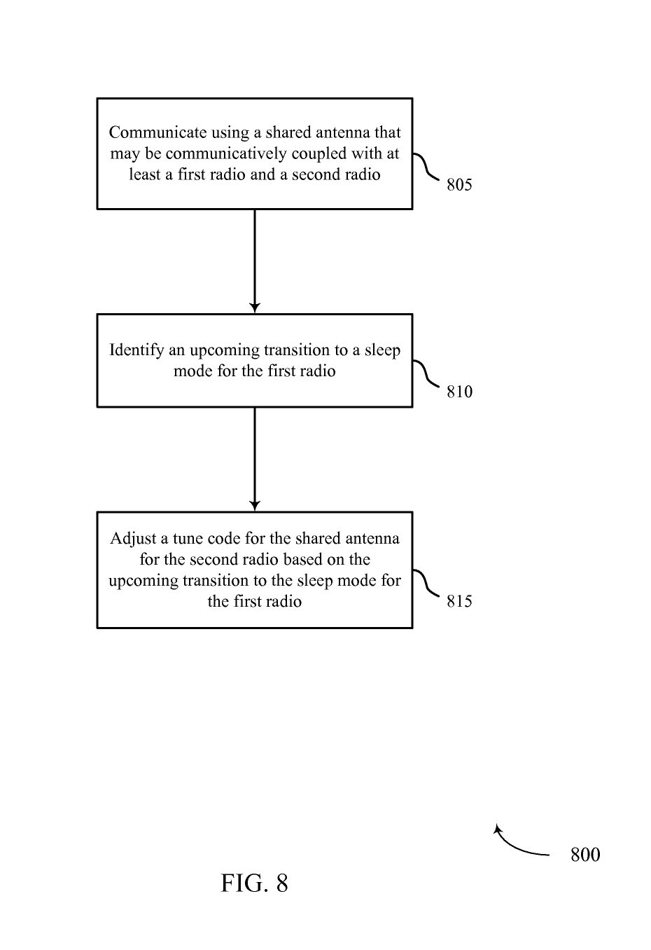

FIG. 8 shows a flowchart illustrating a method 800 for antenna tuner control for WAN/WLAN antenna sharing in accordance with various aspects of the present disclosure. The operations of method 800 may be implemented by a UE 115 or its components as described with reference to FIGS. 1-7. For example, the operations of method 800 may be performed by the shared antenna manager 410 as described with reference to FIGS. 4-7. In some examples, a UE 115 may execute a set of codes to control the functional elements of the UE 115 to perform the functions described below. Additionally or alternatively, the UE 115 may perform aspects the functions described below using special-purpose hardware.

At block 805, the UE 115 may communicate using a shared antenna that is communicatively coupled with at least a first radio and a second radio as described above with reference to FIGS. 2-3. In certain examples, the operations of block 805 may be performed by the communication manager 505 as described above with reference to FIG. 5.

At block 810, the UE 115 may identify an upcoming transition to a sleep mode for the first radio as described above with reference to FIGS. 2-3. In certain examples, the operations of block 810 may be performed by the sleep determiner 510 as described above with reference to FIG. 5.

At block 815, the UE 115 may adjust a tune code for the shared antenna for the second radio based at least in part on the upcoming transition to the sleep mode for the first radio as described above with reference to FIGS. 2-3. In certain examples, the operations of block 815 may be performed by the tuner 515 as described above with reference to FIG. 5.

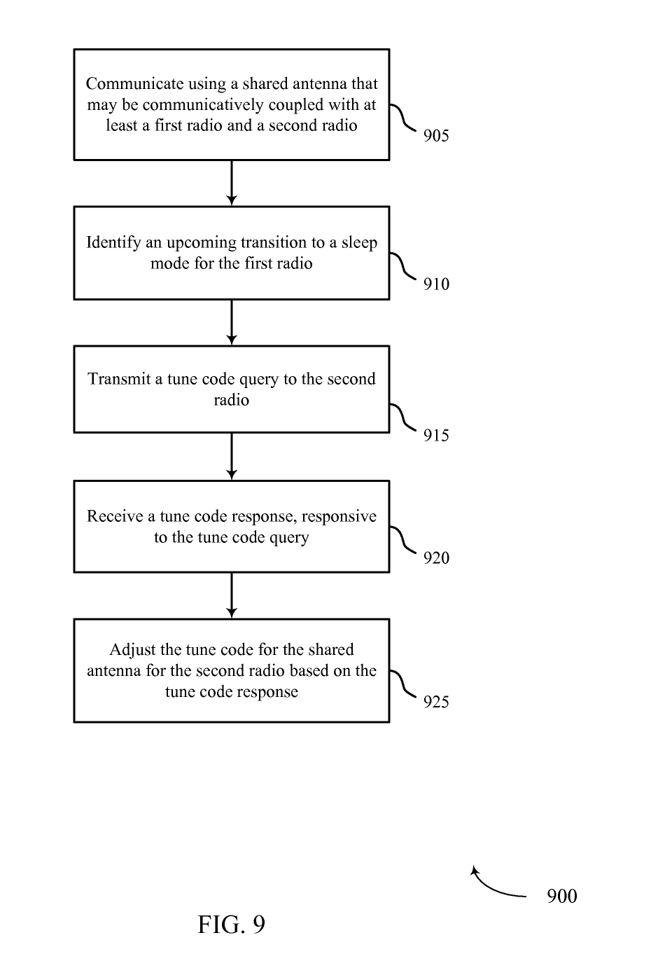

FIG. 9 shows a flowchart illustrating a method 900 for antenna tuner control for WAN/WLAN antenna sharing in accordance with various aspects of the present disclosure. The operations of method 900 may be implemented by a UE 115 or its components as described with reference to FIGS. 1-7. For example, the operations of method 900 may be performed by the shared antenna manager 410 as described with reference to FIGS. 4-7. In some examples, a UE 115 may execute a set of codes to control the functional elements of the UE 115 to perform the functions described below. Additionally or alternatively, the UE 115 may perform aspects the functions described below using special-purpose hardware. The method 900 may also incorporate aspects of method 800 of FIG. 8.

At block 905, the UE 115 may communicate using a shared antenna that is communicatively coupled with at least a first radio and a second radio as described above with reference to FIGS. 2-3. In certain examples, the operations of block 905 may be performed by the communication manager 505 as described above with reference to FIG. 5.

At block 910, the UE 115 may identify an upcoming transition to a sleep mode for the first radio as described above with reference to FIGS. 2-3. In certain examples, the operations of block 910 may be performed by the sleep determiner 510 as described above with reference to FIG. 5.

At block 915, the UE 115 may transmit a tune code query to the second radio as described above with reference to FIGS. 2-3. In certain examples, the operations of block 915 may be performed by the tuner 515 as described above with reference to FIG. 5.

At block 920, the UE 115 may receive a tune code response, responsive to the tune code query as described above with reference to FIGS. 2-3. In certain examples, the operations of block 920 may be performed by the tuner 515 as described above with reference to FIG. 5.

At block 925, the UE 115 may adjust the tune code for the shared antenna for the second radio based at least in part on the tune code response as described above with reference to FIGS. 2-3. In certain examples, the operations of block 925 may be performed by the tuner 515 as described above with reference to FIG. 5.

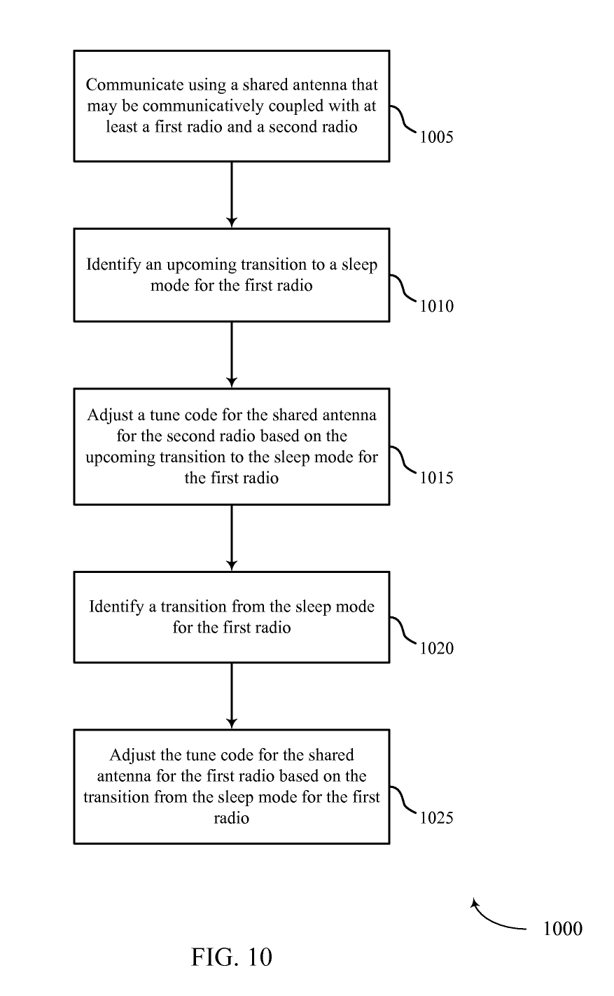

FIG. 10 shows a flowchart illustrating a method 1000 for antenna tuner control for WAN/WLAN antenna sharing in accordance with various aspects of the present disclosure. The operations of method 1000 may be implemented by a UE 115 or its components as described with reference to FIGS. 1-7. For example, the operations of method 1000 may be performed by the shared antenna manager 410 as described with reference to FIGS. 4-7. In some examples, a UE 115 may execute a set of codes to control the functional elements of the UE 115 to perform the functions described below. Additionally or alternatively, the UE 115 may perform aspects the functions described below using special-purpose hardware. The method 1000 may also incorporate aspects of methods 800, and 900 of FIGS. 8-9.

At block 1005, the UE 115 may communicate using a shared antenna that is communicatively coupled with at least a first radio and a second radio as described above with reference to FIGS. 2-3. In certain examples, the operations of block 1005 may be performed by the communication manager 505 as described above with reference to FIG. 5.

At block 1010, the UE 115 may identify an upcoming transition to a sleep mode for the first radio as described above with reference to FIGS. 2-3. In certain examples, the operations of block 1010 may be performed by the sleep determiner 510 as described above with reference to FIG. 5.

At block 1015, the UE 115 may adjust a tune code for the shared antenna for the second radio based at least in part on the upcoming transition to the sleep mode for the first radio as described above with reference to FIGS. 2-3. In certain examples, the operations of block 1015 may be performed by the tuner 515 as described above with reference to FIG. 5.

At block 1020, the UE 115 may identify a transition from the sleep mode for the first radio as described above with reference to FIGS. 2-3. In certain examples, the operations of block 1020 may be performed by the sleep determiner 510 as described above with reference to FIG. 5.

At block 1025, the UE 115 may adjust the tune code for the shared antenna for the first radio based at least in part on the transition from the sleep mode for the first radio as described above with reference to FIGS. 2-3. In certain examples, the operations of block 1025 may be performed by the tuner 515 as described above with reference to FIG. 5.

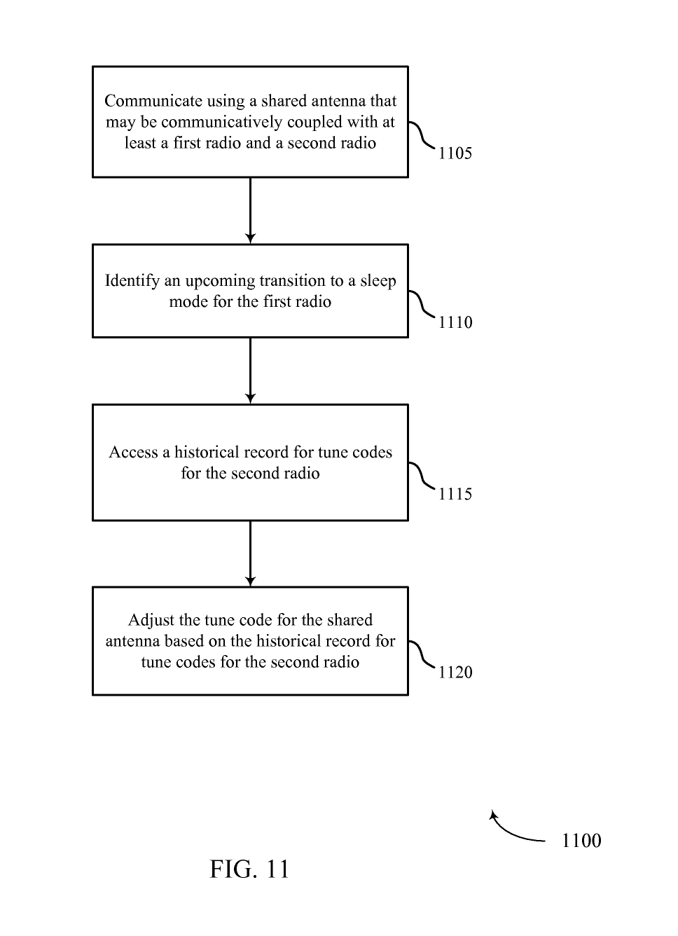

FIG. 11 shows a flowchart illustrating a method 1100 for antenna tuner control for WAN/WLAN antenna sharing in accordance with various aspects of the present disclosure. The operations of method 1100 may be implemented by a UE 115 or its components as described with reference to FIGS. 1-7. For example, the operations of method 1100 may be performed by the shared antenna manager 410 as described with reference to FIGS. 4-7. In some examples, a UE 115 may execute a set of codes to control the functional elements of the UE 115 to perform the functions described below. Additionally or alternatively, the UE 115 may perform aspects the functions described below using special-purpose hardware. The method 1100 may also incorporate aspects of methods 800, 900, and 1000 of FIGS. 8-10.

At block 1105, the UE 115 may communicate using a shared antenna that is communicatively coupled with at least a first radio and a second radio as described above with reference to FIGS. 2-3. In certain examples, the operations of block 1105 may be performed by the communication manager 505 as described above with reference to FIG. 5.

At block 1110, the UE 115 may identify an upcoming transition to a sleep mode for the first radio as described above with reference to FIGS. 2-3. In certain examples, the operations of block 1110 may be performed by the sleep determiner 510 as described above with reference to FIG. 5.

At block 1115, the UE 115 may access a historical record for tune codes for the second radio as described above with reference to FIGS. 2-3. In certain examples, the operations of block 1115 may be performed by the historical record 605 as described above with reference to FIG. 6.

At block 1120, the UE 115 may adjust the tune code for the shared antenna based at least in part on the historical record for tune codes for the second radio as described above with reference to FIGS. 2-3. In certain examples, the operations of block 1120 may be performed by the tuner 515 as described above with reference to FIG. 5.

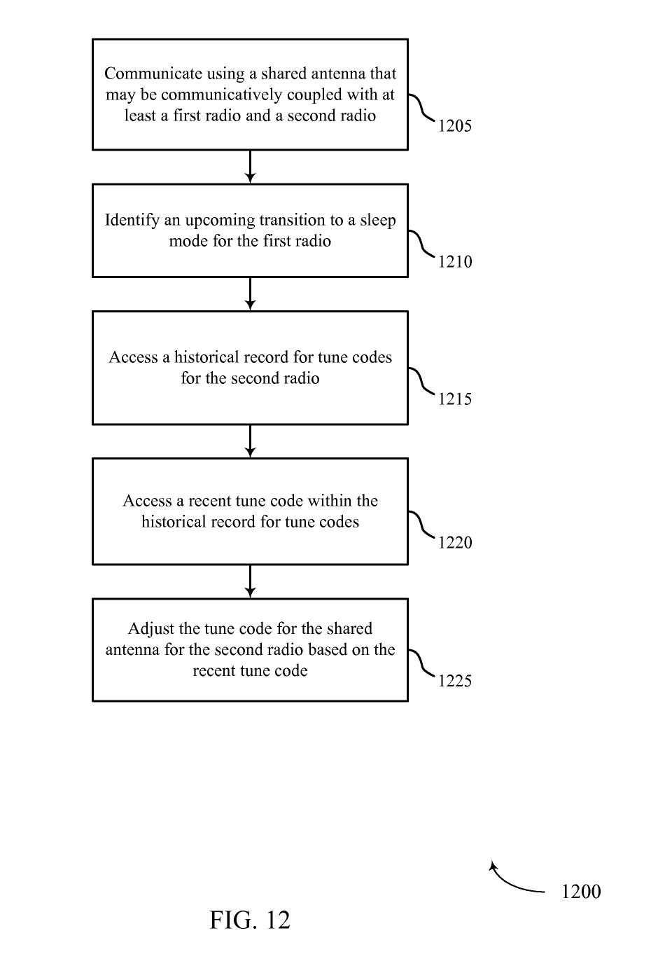

FIG. 12 shows a flowchart illustrating a method 1200 for antenna tuner control for WAN/WLAN antenna sharing in accordance with various aspects of the present disclosure. The operations of method 1200 may be implemented by a UE 115 or its components as described with reference to FIGS. 1-7. For example, the operations of method 1200 may be performed by the shared antenna manager 410 as described with reference to FIGS. 4-7. In some examples, a UE 115 may execute a set of codes to control the functional elements of the UE 115 to perform the functions described below. Additionally or alternatively, the UE 115 may perform aspects the functions described below using special-purpose hardware. The method 1200 may also incorporate aspects of methods 800, 900, 1000, and 1100 of FIGS. 8-11.

At block 1205, the UE 115 may communicate using a shared antenna that is communicatively coupled with at least a first radio and a second radio as described above with reference to FIGS. 2-3. In certain examples, the operations of block 1205 may be performed by the communication manager 505 as described above with reference to FIG. 5.

At block 1210, the UE 115 may identify an upcoming transition to a sleep mode for the first radio as described above with reference to FIGS. 2-3. In certain examples, the operations of block 1210 may be performed by the sleep determiner 510 as described above with reference to FIG. 5.

At block 1215, the UE 115 may access a historical record for tune codes for the second radio as described above with reference to FIGS. 2-3. In certain examples, the operations of block 1215 may be performed by the historical record 605 as described above with reference to FIG. 6.

At block 1220, the UE 115 may access a recent tune code within the historical record for tune codes as described above with reference to FIGS. 2-3. In certain examples, the operations of block 1220 may be performed by the historical record 605 as described above with reference to FIG. 6.

At block 1225, the UE 115 may adjust the tune code for the shared antenna for the second radio based at least in part on the recent tune code as described above with reference to FIGS. 2-3. In certain examples, the operations of block 1225 may be performed by the tuner 515 as described above with reference to FIG. 5.

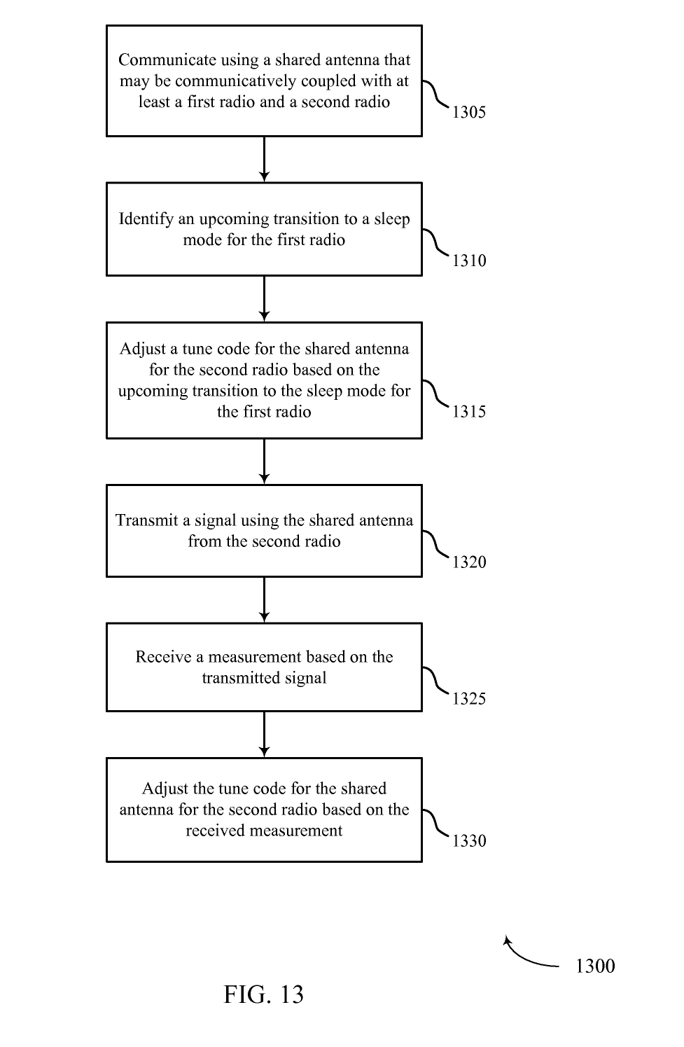

FIG. 13 shows a flowchart illustrating a method 1300 for antenna tuner control for WAN/WLAN antenna sharing in accordance with various aspects of the present disclosure. The operations of method 1300 may be implemented by a UE 115 or its components as described with reference to FIGS. 1-7. For example, the operations of method 1300 may be performed by the shared antenna manager 410 as described with reference to FIGS. 4-7. In some examples, a UE 115 may execute a set of codes to control the functional elements of the UE 115 to perform the functions described below. Additionally or alternatively, the UE 115 may perform aspects the functions described below using special-purpose hardware. The method 1300 may also incorporate aspects of methods 800, 900, 1000, 1100, and 1200 of FIGS. 8-12.

At block 1305, the UE 115 may communicate using a shared antenna that is communicatively coupled with at least a first radio and a second radio as described above with reference to FIGS. 2-3. In certain examples, the operations of block 1305 may be performed by the communication manager 505 as described above with reference to FIG. 5.

At block 1310, the UE 115 may identify an upcoming transition to a sleep mode for the first radio as described above with reference to FIGS. 2-3. In certain examples, the operations of block 1310 may be performed by the sleep determiner 510 as described above with reference to FIG. 5.

At block 1315, the UE 115 may adjust a tune code for the shared antenna for the second radio based at least in part on the upcoming transition to the sleep mode for the first radio as described above with reference to FIGS. 2-3. In certain examples, the operations of block 1315 may be performed by the tuner 515 as described above with reference to FIG. 5.

At block 1320, the UE 115 may transmit a signal using the shared antenna from the second radio as described above with reference to FIGS. 2-3. In certain examples, the operations of block 1320 may be performed by the communication manager 505 as described above with reference to FIG. 5.

At block 1325, the UE 115 may receive a measurement based at least in part on the transmitted signal as described above with reference to FIGS. 2-3. In certain examples, the operations of block 1325 may be performed by the tune quality manager 610 as described above with reference to FIG. 6.

At block 1330, the UE 115 may adjust the tune code for the shared antenna for the second radio based at least in part on the received measurement as described above with reference to FIGS. 2-3. In certain examples, the operations of block 1330 may be performed by the tuner 515 as described above with reference to FIG. 5.

Thus, methods 800, 900, 1000, 1100, 1200, and 1300 may provide for antenna tuner control for WAN/WLAN antenna sharing. It should be noted that methods 800, 900, 1000, 1100, 1200, and 1300 describe possible implementation, and that the operations and the steps may be rearranged or otherwise modified such that other implementations are possible. In some examples, aspects from two or more of the methods 800, 900, 1000, 1100, 1200, and 1300 may be combined.

The detailed description set forth above in connection with the appended drawings describes exemplary embodiments and does not represent all the embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, at least one microprocessor in conjunction with a DSP core, or any other such configuration).

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication at a user equipment (UE), comprising:
communicating using a shared antenna that is communicatively coupled with at least a first radio and a second radio;
identifying an upcoming transition to a sleep mode for the first radio; and
adjusting a tune code for the shared antenna for the second radio based at least in part on the upcoming transition to the sleep mode for the first radio.

2. The method of claim 1, wherein the adjusting the tune code for the shared antenna comprises:
transmitting a tune code query to the second radio;
receiving a tune code response, responsive to the tune code query; and
adjusting the tune code for the shared antenna for the second radio based at least in part on the tune code response.

3. The method of claim 2, wherein the tune code response comprises at least one of a second radio tune code, or a second radio frequency band, or a second radio timing, or a second radio bandwidth, or a second radio power, or combinations thereof.

4. The method of claim 1, further comprising:
identifying a transition from the sleep mode for the first radio; and
adjusting the tune code for the shared antenna for the first radio based at least in part on the transition from the sleep mode for the first radio.

5. The method of claim 1, wherein the adjusting the tune code for the shared antenna comprises:
accessing a historical record for tune codes for the second radio; and
adjusting the tune code for the shared antenna based at least in part on the historical record for tune codes for the second radio.

6. The method of claim 5, wherein the adjusting the tune code for the shared antenna comprises:
accessing a recent tune code within the historical record for tune codes; and
adjusting the tune code for the shared antenna for the second radio based at least in part on the recent tune code.

7. The method of claim 1, further comprising:
transmitting a signal using the shared antenna from the second radio.

8. The method of claim 7, further comprising:
receiving a measurement based at least in part on the transmitted signal; and
adjusting the tune code for the shared antenna for the second radio based at least in part on the received measurement.

9. The method of claim 7, further comprising:
receiving feedback based at least in part on the transmitted signal; and
adjusting the tune code for the shared antenna for the second radio based at least in part on the received feedback.

10. The method of claim 1, wherein the first radio is a wide area network (WAN) radio and the second radio is a wireless local area network (WLAN).

11. The method of claim 1, wherein the tune code is adjusted using a radio frequency front end (RFFE) bus.

12. An apparatus for wireless communication at a user equipment (UE), comprising:
a communication manager for communicating using a shared antenna that is communicatively coupled with at least a first radio and a second radio;
a sleep determiner for identifying an upcoming transition to a sleep mode for the first radio; and
a tuner for adjusting a tune code for the shared antenna for the second radio based at least in part on the upcoming transition to the sleep mode for the first radio.

13. The apparatus of claim 12, wherein the tuner for adjusting the tune code for the shared antenna comprises:
the tuner for transmitting a tune code query to the second radio;
the tuner for receiving a tune code response, responsive to the tune code query; and
the tuner for adjusting the tune code for the shared antenna for the second radio based at least in part on the tune code response.

14. The apparatus of claim 13, wherein the tune code response comprises at least one of a second radio tune code, or a second radio frequency band, or a second radio timing, or a second radio bandwidth, or a second radio power, or combinations thereof.

15. The apparatus of claim 12, further comprising:
a sleep determiner for identifying a transition from the sleep mode for the first radio;
wherein the tuner is further for adjusting the tune code for the shared antenna for the first radio based at least in part on the transition from the sleep mode for the first radio.

16. The apparatus of claim 12, wherein the tuner for adjusting the tune code for the shared antenna comprises:
a historical record for accessing a historical record for tune codes for the second radio; and
the tuner for adjusting the tune code for the shared antenna based at least in part on the historical record for tune codes for the second radio.

17. The apparatus of claim 16, wherein the tuner for adjusting the tune code comprises:
the historical record for accessing a recent tune code within the historical record for tune codes; and
the tuner for adjusting the tune code for the shared antenna for the second radio based at least in part on the recent tune code.

18. The apparatus of claim 12, wherein the communication manager is further for transmitting a signal using the shared antenna from the second radio.

19. The apparatus of claim 18, further comprising:
a tune quality manager for receiving a measurement based at least in part on the transmitted signal;
wherein the tuner is further for adjusting the tune code for the shared antenna for the second radio based at least in part on the received measurement.

20. The apparatus of claim 18, further comprising:
a tune quality manager for receiving feedback based at least in part on the transmitted signal;
wherein the tuner is further for adjusting the tune code for the shared antenna for the second radio based at least in part on the received feedback.

21. An apparatus for wireless communication at a user equipment (UE), comprising:
a processor;
memory in electronic communication with the processor; and
instructions stored in the memory; wherein the instructions are executable by the processor to:
communicate using a shared antenna that is communicatively coupled with at least a first radio and a second radio;
identify an upcoming transition to a sleep mode for the first radio; and
adjust a tune code for the shared antenna for the second radio based at least in part on the upcoming transition to the sleep mode for the first radio.

22. The apparatus of claim 21, wherein the adjusting the tune code for the shared antenna comprises:
transmitting a tune code query to the second radio;
receiving a tune code response, responsive to the tune code query; and
adjusting the tune code for the shared antenna for the second radio based at least in part on the tune code response.

23. The apparatus of claim 22, wherein the tune code response comprises at least one of a second radio tune code, or a second radio frequency band, or a second radio timing, or a second radio bandwidth, or a second radio power, or combinations thereof.

24. The apparatus of claim 21, wherein the instructions are executable by the processor to:
identify a transition from the sleep mode for the first radio; and
adjust the tune code for the shared antenna for the first radio based at least in part on the transition from the sleep mode for the first radio.

25. The apparatus of claim 21, wherein the adjusting the tune code for the shared antenna comprises:
accessing a historical record for tune codes for the second radio; and
adjusting the tune code for the shared antenna based at least in part on the historical record for tune codes for the second radio.

26. The apparatus of claim 21, wherein the instructions are executable by the processor to:
transmit a signal using the shared antenna from the second radio.

27. The apparatus of claim 26, wherein the instructions are executable by the processor to:
receive a measurement based at least in part on the transmitted signal; and
adjust the tune code for the shared antenna for the second radio based at least in part on the received measurement.

28. The apparatus of claim 26, wherein the instructions are executable by the processor to:
receive feedback based at least in part on the transmitted signal; and
adjust the tune code for the shared antenna for the second radio based at least in part on the received feedback.

29. A non-transitory computer-readable medium storing code for wireless communication at a user equipment (UE), the code comprising instructions executable to:
communicate using a shared antenna that is communicatively coupled with at least a first radio and a second radio;
identify an upcoming transition to a sleep mode for the first radio; and
adjust a tune code for the shared antenna for the second radio based at least in part on the upcoming transition to the sleep mode for the first radio.

30. The non-transitory computer-readable medium of claim 29, wherein the adjusting the tune code for the shared antenna comprises:
transmitting a tune code query to the second radio;
wherein the instructions are executable to receive a tune code response, responsive to the tune code query; and
adjust the tune code for the shared antenna for the second radio based at least in part on the tune code response.
